(19) United States
(12) Patent Application Publication
(10) Pub. No.: US 2018/0376389 A1
(43) Pub. Date: Dec. 27, 2018

(54) VEHICLE AND CONTROL METHOD THEREOF

(71) Applicants: Hyundai Motor Company, Seoul (KR); Kia Motors Corporation, Seoul (KR)

(72) Inventors: Jungnam BAE, Seoul (KR); Jang Soon HAN, Seongnam-si (KR)

(73) Assignees: Hyundai Motor Company, Seoul (KR); Kia Motors Corporation, Seoul (KR)

(21) Appl. No.: 15/799,788

(22) Filed: Oct. 31, 2017

(30) Foreign Application Priority Data
Jun. 23, 2017 (KR) 10-2017-0079657

(51) Int. Cl. H04W 36/00; H04L 29/08; H04W 4/04; H04W 84/00

(52) U.S. Cl. CPC H04W 36/0083; H04L 67/12; B60W 2750/40; H04W 84/005; B60W 2550/40; H04W 4/046

(57) ABSTRACT

A vehicle may include a mobile communication device, a traffic information receiver and a controller, wherein the mobile communication device communicates with a first communication infrastructure among a plurality of communication infrastructures, wherein the traffic information receiver communicates with a traffic infrastructure, and wherein the controller is configured to receive information related to communication states of the plurality of communication infrastructures from the traffic infrastructure through the traffic information receiver, and performs a handover from the first communication infrastructure to a second communication infrastructure according to a first communication state information related to the first communication infrastructure and a second communication state information related to the second communication infrastructure.

### CROSS-REFERENCE(S) TO RELATED APPLICATION

The present application claims priority to Korean Patent Application No. 10-2017-0079657, filed on Jun. 23, 2017, the entire contents of which is incorporated herein for all purposes by this reference.

### BACKGROUND OF THE INVENTION

### Field of the Invention

The present invention relates to a vehicle and a control method thereof, and, more particularly, to a vehicle configured to communicate with a communication infrastructure, a traffic infrastructure, and another vehicle, a method of controlling the vehicle, and a communication apparatus for the vehicle.

### Description of Related Art

A vehicle is a device of transportation which drives on a road or a rail using fossil fuels or electricity as a power source.

Many vehicles include an audio system and a video system to allow a driver to listen to music and watch videos while driving, in addition to a function of transporting goods or persons in the vehicle, and also includes a navigation system to display a route to a driver's destination.

Lately, a demand for a vehicle configured to communicate with a plurality of external devices is increasing.

For example, a navigation function to guide a route to a destination requires information regarding traffic situations of roads to determine an optimal route. However, since such traffic situations are dynamic and change frequently, a vehicle needs to acquire information related to the traffic situations in real time.

The information disclosed in the present Background of the Invention section is only for enhancement of understanding of the general background of the invention and should not be taken as an acknowledgement or any form of suggestion that the present information forms the prior art already known to a person skilled in the art.

### BRIEF SUMMARY

Various aspects of the present invention are directed to providing a vehicle configured to communicate with a communication infrastructure, a traffic infrastructure, and another vehicle, and a method of controlling the vehicle.

Various aspects of the present invention are directed to providing a vehicle configured to reduce a communication traffic of a communication infrastructure through handover, and a method of controlling the vehicle.

Additional aspects of the present invention will be set forth in part in the description which follows and, in part, will be obvious from the description, or may be learned by practice of the present invention.

In accordance with an aspect of the present invention, a vehicle includes a mobile communication device, a traffic information receiver and a controller. The mobile communication device may communicate with a first communication infrastructure among a plurality of communication infrastructures. The traffic information receiver may communicate with a traffic infrastructure. Furthermore, the controller may be configured to receive information related to communication states of the plurality of communication infrastructures from the traffic infrastructure through the traffic information receiver, and perform a handover from the first communication infrastructure to a second communication infrastructure according to a first communication state information related to the first communication infrastructure and a second communication state information related to the second communication infrastructure.

The controller may be configured to determine a first additional connection capability and a second additional connection capability from the first communication state information and the second communication state information, and prevent the handover from the first communication infrastructure to the second communication infrastructure, when a ratio of the second additional connection capability to the first additional connection capability is less than or equal to a reference value.

When the controller prevents the handover and then determines that the vehicle is out of a communication cell of the first communication infrastructure, the controller may be configured to perform a Vehicle-to-Vehicle (V2V) communication with a first vehicle located in the communication cell of the first communication infrastructure, and perform a multi-hop relay communication with the first communication infrastructure using the V2V communication with the first vehicle.

The controller may be configured to determine the first additional connection capability and the second additional connection capability from the first communication state information and the second communication state information, and perform the handover from the first communication infrastructure to the second communication infrastructure, when the ratio of the second additional connection capability to the first additional connection capability is greater than the reference value.

When the controller performs the handover and then determines that the vehicle is out of a communication cell of the second communication infrastructure, the controller may perform a Vehicle-to-Vehicle (V2V) communication with a second vehicle located in a communication cell of the second communication infrastructure, and perform a multi-hop relay communication with the second communication infrastructure using the V2V communication with the second vehicle.

The controller may be configured to extract a first current connection capability and a first maximum connection capability from the first communication state information, determine a first margin rate of the communication capability representing a ratio of the first maximum connection capability to the first current connection capability, extracts a second current connection capability and a second maximum connection capability from the second communication state information, and determine a second margin rate of the communication capability representing a ratio of the second maximum connection capability to the second current connection capability.

When a ratio of the second margin rate of the communication capability to the first margin rate of the communication capability is less than or equal to a reference value, the controller may be configured to prevent the handover from the first communication infrastructure to the second communication infrastructure. Furthermore, when the ratio of the second margin rate of the communication capability to the first margin rate of the communication capability is greater than the reference value, the controller may be configured to perform the handover from the first communication infrastructure to the second communication infrastructure.

In accordance with an aspect of the present invention, a method of controlling a vehicle includes communicating with a first communication infrastructure among a plurality of communication infrastructures, communicating with a traffic infrastructure, receiving information related to communication states of the plurality of communication infrastructures from the traffic infrastructure, and performing a handover from the first communication infrastructure to the second communication infrastructure according to a first communication state information related to the first communication infrastructure and a second communication state information related to the second communication infrastructure.

The performing of the handover may include determining a first additional connection capability and a second additional connection capability from the first communication state information and the second communication state information, and preventing the handover from the first communication infrastructure to the second communication infrastructure, when a ratio of the second additional connection capability to the first additional connection capability is less than or equal to a reference value.

The method further includes performing a Vehicle-to-Vehicle (V2V) communication with a first vehicle located in a communication cell of the first communication infrastructure when preventing the handover and then determining that the vehicle is out of a communication cell of the first communication infrastructure, and performing a multi-hop relay communication with the first communication infrastructure using the V2V communication with the first vehicle.

The performing of the handover may include determining the first additional connection capability and the second additional connection capability from the first communication state information and the second communication state information, and performing the handover from the first communication infrastructure to the second communication infrastructure, when a ratio of the second additional connection capability to the first additional connection capability is greater than a reference value.

The method further includes performing a Vehicle-to-Vehicle (V2V) communication with a second vehicle located in a communication cell of the second communication infrastructure when performing the handover and then determining that the vehicle is out of the communication cell of the second communication infrastructure, and performing a multi-hop relay communication with the second communication infrastructure using the V2V communication with the second vehicle.

The performing of the handover may include extracting a first current connection capability and a first maximum connection capability from the first communication state information, determining a first margin rate of the communication capability representing a ratio of the first maximum connection capability to the first current connection capability, extracting a second current connection capability and a second maximum connection capability from the second communication state information, and determining a second margin rate of the communication capability representing a ratio of the second maximum connection capability to the second current connection capability.

The performing of the handover may further include preventing the handover from the first communication infrastructure to the second communication infrastructure, when a ratio of the second margin rate of the communication capability to the first margin rate of the communication capability is less than or equal to a reference value, and performing the handover from the first communication infrastructure to the second communication infrastructure, when the ratio of the second margin rate of the communication capability to the first margin rate of the communication capability is greater than the reference value.

In accordance with an aspect of the present invention, a vehicle configured to communicate with a plurality of communication infrastructures includes a mobile communication device and a controller. The mobile communication device may communicate with a first communication infrastructure among the plurality of communication infrastructures. The controller may be configured to receive information related to communication states of the plurality of communication infrastructures from the first communication infrastructure, and prevent or perform a handover from the first communication infrastructure to a second communication infrastructure according to a first communication state information related to the first communication infrastructure and a second communication state information related to the second communication infrastructure. When the controller prevents the handover and then determines that the vehicle is out of a communication cell of the first communication infrastructure, the controller may be configured to perform a multi-hop relay communication with the first communication infrastructure using a Vehicle-to-Vehicle (V2V) communication with a first vehicle located in the communication cell of the first communication infrastructure. Furthermore, when the controller performs the handover and then determines that the vehicle is out of a communication cell of the second communication infrastructure, the controller may perform a multi-hop relay communication with the second communication infrastructure using a V2V communication with a second vehicle located in the communication cell of the second communication infrastructure.

The controller may be configured to determine a first additional connection capability and a second additional connection capability from the first communication state information and the second communication state information, and prevent the handover from the first communication infrastructure to the second communication infrastructure, when a ratio of the second additional connection capability to the first additional connection capability is less than or equal to a reference value.

The controller may be configured to determine the first additional connection capability and the second additional connection capability from the first communication state information and the second communication state information, and perform the handover from the first communication infrastructure to the second communication infrastructure, when a ratio of the second additional connection capability to the first additional connection capability is greater than a reference value.

The controller may be configured to extract a first current connection capability and a first maximum connection capability from the first communication state information, and extract a second current connection capability and a second maximum connection capability from the second communication state information.

The controller may be configured to determine a first margin rate of the communication capability representing a ratio of the first maximum connection capability to the first current connection capability, and determine a second margin rate of the communication capability representing a ratio of the second maximum connection capability to the second current connection capability.

When a ratio of the second margin rate of the communication capability to the first margin rate of the communication capability is less than or equal to a reference value, the controller may be configured to prevent the handover from the first communication infrastructure to the second communication infrastructure. Furthermore, when the ratio of the second margin rate of communication capability to the first margin rate of communication capability is greater than the reference value, the controller may be configured to perform the handover from the first communication infrastructure to the second communication infrastructure.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 shows a vehicle according to an exemplary embodiment of the present invention;

FIG. 2 shows a chassis of a vehicle according to an exemplary embodiment of the present invention;

FIG. 3 is a block diagram of a plurality of electric components of a vehicle according to an exemplary embodiment of the present invention;

FIG. 4 is a block diagram of a wireless communication apparatus included in a vehicle according to an exemplary embodiment of the present invention;

FIG. 5 is a view for describing a wireless communication between a vehicle according to an exemplary embodiment of the present invention and a communication/traffic infrastructure;

FIG. 6 is a view for describing a handover which a vehicle according to an exemplary embodiment of the present invention performs with communication infrastructures;

FIG. 7 is a flowchart illustrating a handover method of a vehicle according to an exemplary embodiment of the present invention;

FIG. 8 is a view for describing an exemplary embodiment in which a vehicle according to an exemplary embodiment of the present invention performs a handover between communication infrastructures;

FIG. 9 is a view for describing another exemplary embodiment in which a vehicle according to an exemplary embodiment of the present invention performs a handover between communication infrastructures; and

FIG. 10 is a view for describing yet another exemplary embodiment in which a vehicle according to an exemplary embodiment of the present invention performs a handover between communication infrastructures.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within in the spirit and scope of the invention as defined by the appended claims.

It will be understood that, although the terms first, second, etc. may be used herein to describe various elements, these elements may not be limited by these terms. These terms are only used to distinguish one element from another. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present.

The terminology used herein is for describing embodiments only and is not intended to be limiting. As used herein, the singular forms “a,” “an,” and “the,” are intended to include the plural forms as well, unless the context clearly indicates otherwise.

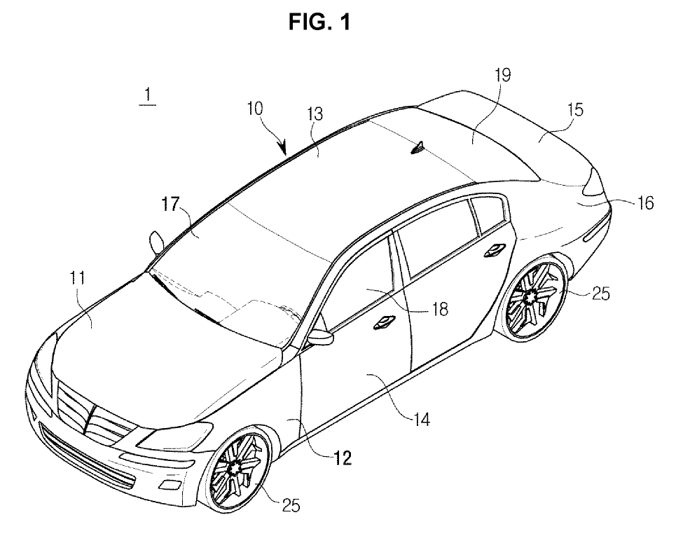

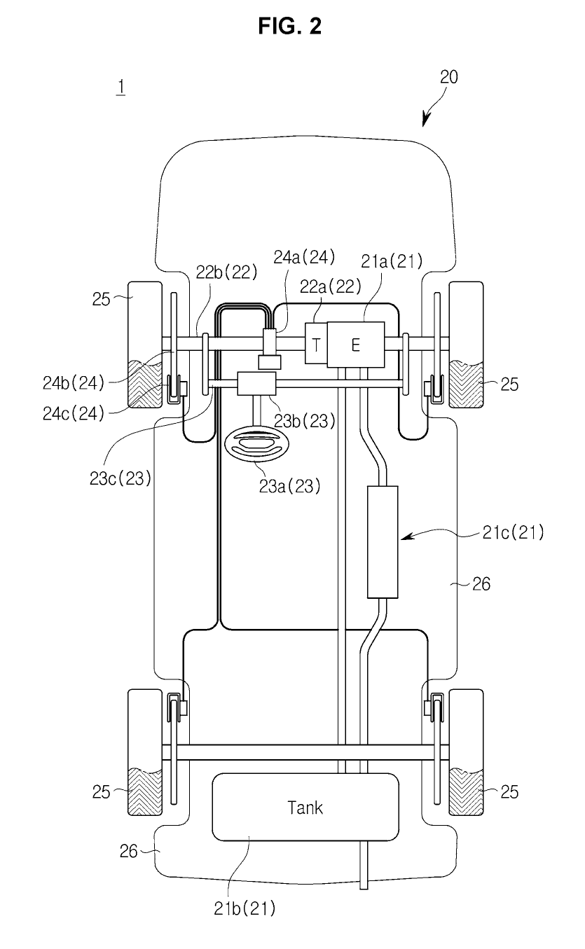

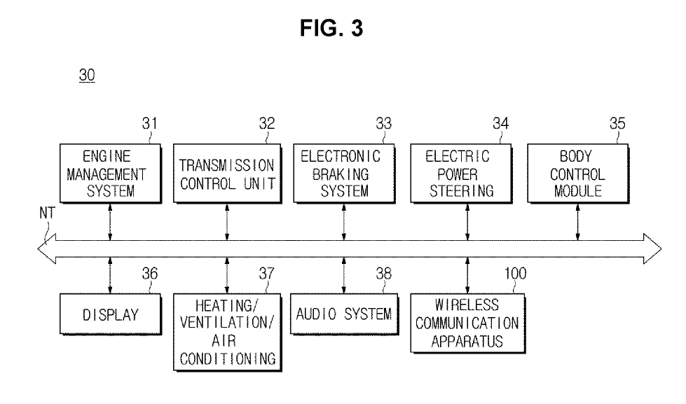

FIG. 1 shows a vehicle according to an exemplary embodiment of the present invention. FIG. 2 shows a chassis of a vehicle according to an exemplary embodiment of the present invention. FIG. 3 is a block diagram of a plurality of electric components of a vehicle according to an exemplary embodiment of the present invention.

Referring to FIG. 1, FIG. 2, and FIG. 3, a vehicle 1 may include a body 10 forming an external appearance of the vehicle 1 and accommodating a driver and/or various goods to be transported, a chassis 20 including components of the vehicle 1 except for the body 10, and a plurality of electric components 30 configured to protect the driver and provide the driver with a convenience.

For example, as shown in FIG. 1, the body 10 may form internal compartment where the driver is accommodated, an engine compartment to accommodate an engine therein, and a trunk compartment to accommodate goods therein.

The body 20 may include a hood 11, a front fender 12, a roof panel 13, a plurality of doors 14, a trunk lid 15, and a quarter panel 16. Also, to ensure the driver's field of view, a front window 17 may be disposed in a front portion of the body 10, side windows 18 may be disposed in both sides of the body 10, and a rear window 19 may be disposed in a rear portion of the body 10.

For example, as shown in FIG. 2, the chassis 20 may include a power generating apparatus 21, a power transferring apparatus 22, a steering apparatus 23, a brake apparatus 24, a plurality of wheels 25, a frame 26, etc. all of which are configured to enable the vehicle 1 to travel according to the driver's control.

The power generating apparatus 21 may be configured to generate a rotational force for driving the vehicle 1 according to the driver's acceleration control, and includes an engine 21a, a fuel supply apparatus, or tank, 21b, an exhaust apparatus 21c, an throttle, etc.

The power transferring apparatus 22 may be configured to transfer a rotational force generated by the power generating apparatus 21 to the wheels 25, and includes a clutch/transmission 22a, a drive-shaft 22b, a gearshift, etc.

The steering apparatus 23 may be configured to change a driving direction of the vehicle 1 according to the driver's steering control, and includes a steering wheel 23a, a steering gear 23b, a steering link 23c, etc.

The brake apparatus 24 may be configured to stop the vehicle 1 according to the driver's brake control, and includes a master cylinder 24a, a brake disc 24b, a brake pad 24c, a brake pedal, etc.

The wheels 25 may be configured to receive the rotational force from the power generating apparatus 21 through the power transferring apparatus 22 to move the vehicle 1. The wheels 25 may include front wheels 25 disposed in the front portion of the vehicle 1, and rear wheels 25 disposed in the rear portion of the vehicle. 1.

The frame 26 may be configured to fix the power generating apparatus 21, the power transferring apparatus 22, the steering apparatus 23, the brake apparatus 24, and the wheels 25 to the vehicle body 10.

The vehicle 1 may include various electric components 30 configured for controlling the vehicle 1 and providing the driver and occupants with convenience and safety, in addition to the above-described mechanical components.

For example, as shown in FIG. 3, the vehicle 1 may include an Engine Management System (EMS) 31, a Transmission Control Unit (TCU) 32, an Electronic Braking System (EBS) 33, an Electric Power Steering (EPS) 34, a Body Control Module (BCM) 35, a display 36, a Heating/Ventilation/Air Conditioning (HVAC) system 37, an audio system 38, and a wireless communication apparatus 100.

The EMS 31 may be configured to control an operation of the engine 21 a and manage the engine 21a, in response to the driver's acceleration command received through the throttle. For example, the EMS 31 may perform an engine torque control, a fuel efficiency control, an engine failure diagnosis, and/or a generator control.

The TCU 32 may be configured to control an operation of the transmission in response to the driver's gear-shifting command received through the gearshift or in response to the driving speed of the vehicle 1. For example, the TCU 32 may perform a clutch control, a transmission control, and/or the engine torque control during gear-shifting.

The EBS 33 may be configured to control a brake system of the vehicle 1 and maintain a balance of the vehicle 1, in response to the driver's brake command received through the brake pedal. For example, the EBS 33 may perform an automatic parking braking, a slip prevention during braking, and/or a slip prevention during steering.

The EPS 34 may be configured to assist the driver to easily manipulate the steering wheel 34a. For example, the EPS 34 may assist the driver's steering manipulation by decreasing a steering torque upon low-speed driving or parking, and increasing the steering torque upon high-speed driving.

The BCM 35 may be configured to control the operation of the electric components 30 for providing the driver with convenience or ensuring the driver's safety. For example, the BCM 35 may control a door lock apparatus, a head lamp, wipers, a power seat, a seat heater, a cluster, an internal lamp, a navigation system, a multi-functional switch, etc. disposed in the vehicle 1.

The display 36 may be disposed in a center fascia within the vehicle 1 to provide the driver with various information and entertainment through a screen. For example, the display 36 may reproduce a video file stored in an internal storage medium or an external storage medium according to the driver's command, and output images included in the video file.

Also, the display 36 may receive information related to a destination from the driver through the driver's touch input, and display a route to the destination.

The HVAC system 37 may heat or cool internal air according to an internal temperature of the vehicle 1 and a target temperature input by the driver. For example, when the internal temperature is higher than the target temperature, the HVAC system 37 may cool internal air, and when the internal temperature is lower than the target temperature, the HVAC system 37 may heat the internal air. Also, the HVAC system 37 may cause external air of the vehicle 1 to flow to the internal of the vehicle 1, or prevent external air of the vehicle 1 from flowing to the internal of the vehicle 1, according to an external environment of the vehicle 1, and recirculate the internal air of the vehicle 1.

The audio system 38 may be configured to provide the driver with various information and entertainment through sound. For example, the audio system 38 may reproduce a video file stored in the internal storage medium or the external storage medium according to the driver's command, and output sound included in audio data of the video file. Also, the audio system 38 may receive an audio broadcasting signal, and output a sound corresponding to the received audio broadcasting signal.

The wireless communication apparatus 100 may be configured to communicate with a communication infrastructure, a traffic infrastructure, and another vehicle. The communication infrastructure may include a base station configured to provide wireless mobile communications, and the traffic infrastructure may include a traffic light displaying traffic signals, a sign board displaying traffic information, etc. The wireless communication apparatus 100 may transmit data to the communication infrastructure, the traffic infrastructure, and the other vehicle in a wireless fashion, and receive data in a wireless fashion.

A structure and operation of the wireless communication apparatus 100 will be described in more detail, below.

In addition, the vehicle 1 may further include electric components 30 to protect the driver and provide the driver with convenience. For example, the vehicle 1 may include electric components 30, including a door lock apparatus, wipers, a power seat, a seat heater, a cluster, an internal lamp, a navigation system, and a multi-functional switch.

The electric components 30 may communicate with each other through a communication network (NT) for the vehicle 1. For example, the electric components 30 may transmit and receive data through the Ethernet, Media Oriented Systems Transport (MOST), Flexray, Controller Area Network (CAN), Local Interconnect Network (LIN), etc.

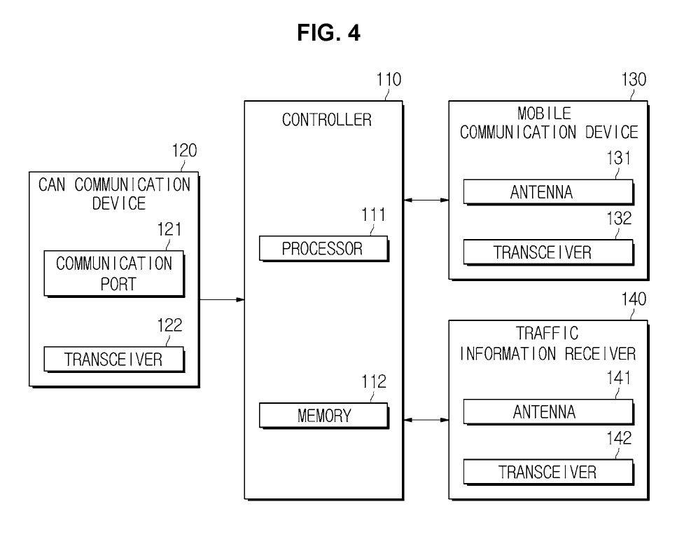

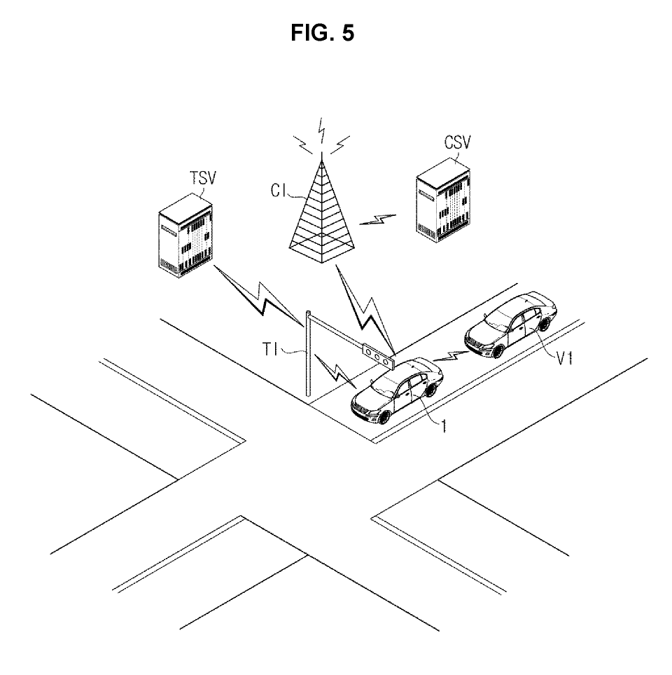

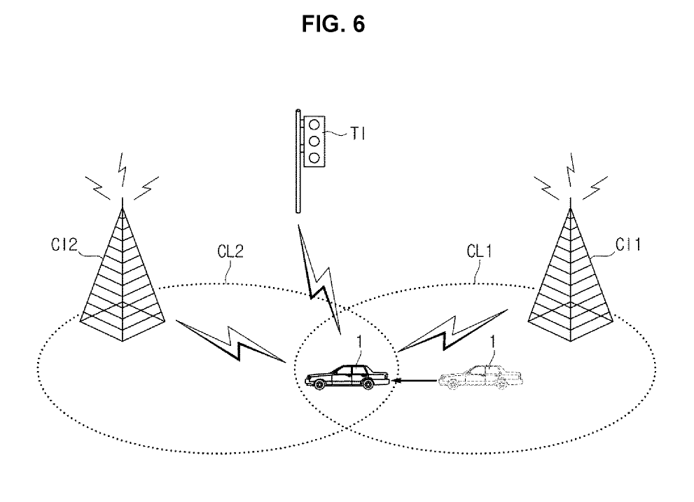

FIG. 4 is a block diagram of a wireless communication apparatus included in a vehicle according to an exemplary embodiment of the present invention. FIG. 5 is a view for describing wireless communication between a vehicle according to an exemplary embodiment of the present invention and a communication/traffic infrastructure. FIG. 6 is a view for describing a handover which a vehicle according to an exemplary embodiment of the present invention performs with communication infrastructures.

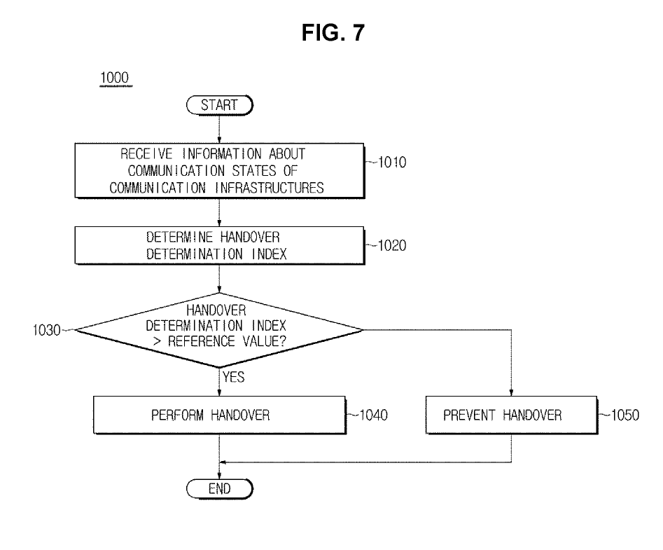

Hereinafter, components of the wireless communication apparatus 100 included in the vehicle 1 and operations of the components will be described with reference to FIG. 4, FIG. 5, and FIG. 7.

As shown in FIG. 4, the wireless communication apparatus 100 may include a CAN communication device 120 configured to communicate with the electric components 30 of the vehicle 1 through a NT for the vehicle 1, a mobile communication device 130 configured to communicate with a communication infrastructure CI in a wireless fashion, a traffic information receiver 140 configured to communicate with a traffic infrastructure in a wireless fashion, and a controller 110 configured to control the operations of the components 30 included in the wireless communication apparatus 100.

The CAN communication device 120 may communicate with the other electric components 30 through the NT for the vehicle 1. For example, the CAN communication device 120 may transmit or receive communication signals through the NT for the vehicle 1 in response to control signals from the controller 110.

The CAN communication device 120 may include a communication port 121 connected to the NT for the vehicle 1, and a transceiver 122 to transmit and receive communication signals through the NT for the vehicle 1.

The communication port 121 may connect the wireless communication apparatus 100 to the NT for the vehicle 1. The wireless communication apparatus 100 may transmit a communication signal to the NT for the vehicle 1 through the communication port 121, and receive a communication signal from the NT for the vehicle 1 through the communication port 121.

The transceiver 122 may convert an analog communication signal received from the NT for the vehicle 1 through the communication port 121 into digital communication data, and output the digital communication data to the controller 110. Herein, the communication signal may be a signal which is transmitted and received through the NT for the vehicle 1, and the communication data may be a signal which is transmitted and received in the wireless communication apparatus 100. The communication signal and the communication data may have different formats.

The transceiver 122 of the CAN communication device 120 may convert digital communication data received from the controller 110 to an analog communication signal, and transmit the analog communication signal to the NT for the vehicle 1 through the communication port 121.

The transceiver 122 may include memory to store data and programs for converting communication signals, and a processor to modulate/demodulate communication signals according to the programs and data stored in the memory.

The mobile communication device 130 may communicate with a communication infrastructure CI or another vehicle V1 in a wireless fashion, as shown in FIG. 5.

For example, the mobile communication device 130 may transmit a communication signal to the communication infrastructure CI in a wireless fashion in response to a control signal from the controller 110. The communication signal transmitted to the communication infrastructure CI may be transmitted to a communication service server CSV. Also, a communication signal output from the communication service server CSV may be transmitted to the mobile communication device 130 via the communication infrastructure CI. Herein, the communication service server CSV may collect information related to communication states of the communication infrastructures CI, and process the information to provide a stable mobile communication service.

Also, the mobile communication device 130 may transmit a communication signal to the other vehicle V1 in a wireless fashion in response to a control signal from the controller 110, and receive a communication signal from the other vehicle V1 in a wireless fashion.

The mobile communication device 130 may include an antenna 131 to omni-transmit electromagnetic waves and to omni-collect electromagnetic waves, and a transceiver 132 to transmit and receive a communication signal through the antenna 131.

The antenna 131 may omni-receive electromagnetic waves to convert the electromagnetic waves into an electric wireless signal, and also may convert an electric wireless signal to electromagnetic waves to omni-transmit the electromagnetic waves. A size and a shape of the antenna 131 may be determined depending on a frequency (or a wavelength) of the electromagnetic waves which the antenna 131 transmits or receives.

The antenna 131 may form various forms of beam patterns according to a control signals from the controller 110.

The antenna 131 may form a beam pattern to communicate with a communication target (a communication infrastructure and/or another vehicle) located in a predetermined direction and/or at a predetermined distance. In other words, the antenna 131 may selectively transmit a wireless signal to a communication target located in a beam pattern, and selectively receive a wireless signal from the communication target located in the beam pattern.

To form the beam pattern, the antenna 131 may include an array antenna including a plurality of radiation patterns each configured for transmitting or receiving electromagnetic waves. The array antenna may transmit electromagnetic waves having the same frequency and the same phase from the plurality of radiation patterns, and the electromagnetic waves radiated from the plurality of radiation patterns may overlap to form a beam pattern expanding in a specific direction thereof.

The transceiver 132 may convert an analog wireless signal received through the antenna 131 into digital communication data to output the digital communication data to the controller 110, and may convert digital communication data received from the controller 110 to an analog wireless signal to output the analog wireless signal to the antenna 131.

The transceiver 132 may perform a conversion between an analog wireless signal and digital communication data according to various mobile communication protocols.

For example, the transceiver 132 may perform the conversion between an analog wireless signal and digital communication data according to a communication protocol, including Time Division Multiple Access (TDMA), Code Division Multiple Access (CDMA), Wide Code Division Multiple Access (WCDMA), Code Division Multiple Access 2000 (CDMA2000), Wireless Broadband (Wibro), and World Interoperability for Microwave Access (WiMAX), Long Term Evolution (LTE), and Wireless Broadband Evolution (Wibro Evolution).

Also, the transceiver 132 may perform the conversion between an analog wireless signal and digital communication data according to a communication protocol (for example, a 5Generation (5G) communication protocol) which will be commercialized in a near feature, as well as known communication protocols.

Accordingly, the mobile communication device 130 may convert a wireless signal received from a communication infrastructure CI or another vehicle V1 permeated through free space into digital communication data, and provide the digital communication data to the controller 110. Also, the mobile communication device 130 may convert digital communication data received from the controller 110 to a wireless signal, and transmit the wireless signal to the communication infrastructure CI or the other vehicle VI, by permeating through the free space.

The mobile communication device 130 may form a beam pattern to communicate with a communication target located in a predetermined direction and/or at a predetermined distance.

Also, the mobile communication device 130 may communicate with another vehicle V1, as well as a communication infrastructure CI including a base station. In other words, the mobile communication device 130 may perform a Vehicle to Vehicle (V2V) communication. The V2V communication may enable a transmission of wireless signals between vehicles, not via a base station, which saves energy.

Furthermore, the mobile communication device 130 may perform a relay transmission of wireless signals in a multi-hop fashion. In other words, the vehicle 1 may communicate with a communication infrastructure through another vehicle Vl. When the vehicle 1 is out of a communication distance of the communication infrastructure CI, the vehicle 1 may transmit a wireless communication signal to another vehicle V1, and the communication infrastructure CI may receive the wireless communication signal of the vehicle 1 from the other vehicle V1. Also, the communication infrastructure CI may transmit a wireless communication signal to the other vehicle V1, and the vehicle 1 may receive the wireless communication signal of the communication infrastructure CI from the other vehicle V1.

The traffic information receiver 140 may receive various information from the traffic infrastructure TI in a wireless fashion, as shown in FIG. 5.

For example, the traffic information receiver 140 may receive a traffic signal information output from the traffic service server TSV from a traffic light located at an intersection and the like, or receive traffic situations information output from the traffic service server TSV from a streetlamp located on a road. Herein, the traffic service server TSV may transmit processed information related to the traffic situations to the vehicle 1 through the traffic infrastructure TI.

Also, the traffic information receiver 140 may receive various information through a broadcasting signal. For example, the traffic information receiver 140 may receive information related to the traffic situations included in a Digital Multimedia Broadcasting (DMB) signal.

The traffic information receiver 140 may receive traffic information from the traffic service server TSV, and also receive information related to a communication state of the communication infrastructure CI from the traffic service server TSV. For example, the traffic information receiver 140 may receive information related to a communication traffic of the communication infrastructure CI from the traffic service server TSV.

The traffic information receiver 140 may include an antenna 141 to omni-transmit electromagnetic waves and to omni-receive electromagnetic waves, and a transceiver 142 to transmit and receive a communication signal through the antenna 141.

The antenna 141 of the traffic information receiver 140 may omni-receive, like the antenna 131 of the mobile communication device 130, electromagnetic waves to convert the electromagnetic waves into an electric wireless signal, and also, may convert an electric wireless signal into electromagnetic waves to omni-transmit the electromagnetic waves.

However, since a communication frequency of the traffic information receiver 140 is different from a communication frequency of the mobile communication device 130, a shape and a size of the antenna 141 of the traffic information receiver 140 may be different from the shape and the size of the antenna 131 of the mobile communication device 130.

However, the antenna 141 of the traffic information receiver 140 and the antenna 131 of the mobile communication device 130 may be integrated into a body to form an antenna module.

The transceiver 142 may convert an analog wireless signal received through the antenna 141 into digital communication data to output the digital communication data to the controller 110, and convert digital communication data received from the controller 110 into an analog wireless signal to output the analog wireless signal to the antenna 141.

The transceiver 142 may perform the conversion between an analog wireless signal and digital communication data according to a DMB protocol or a communication protocol defined with the traffic infrastructure TI.

Accordingly, the traffic information receiver 140 may convert a wireless signal received from the traffic infrastructure TI permeated through free space into digital communication data, and provide the digital communication data to the controller 110. Also, the traffic information receiver 140 may convert digital communication data received from the controller 110 into a wireless signal, and transmit the wireless signal to the traffic infrastructure TI, by permeating through free space.

The controller 110 may include memory 112 configured to store control data and control programs for controlling the vehicle 1 and/or the wireless communication apparatus 100, and a processor 111 configured to generate control signals according to the control programs and control data stored in the memory 112.

The memory 112 may store communication data received through the CAN communication device 120, the mobile communication device 130, and/or the traffic information receiver 140, or store communication data thatto is configured to be transmitted through the CAN communication device 120, the mobile communication device 130, and/or the traffic information receiver 140. Also, the memory 112 may provide programs and/or data stored in the memory 112 to the processor 111 according to a control signal from the controller 110.

The memory 112 may be a volatile memory, including Static Random Access Memory (SRAM) and Dynamic Random Access Memory (DRAM). Also, the memory 112 may be non-volatile memory, including Read Only Memory (ROM), Erasable Programmable Read Only Memory (EPROM), and Electrically Erasable Programmable Read Only Memory (EEPROM), to store programs for booting or power-on resetting the wireless communication apparatus 100.

The processor 111 may include various logic circuits and operation circuits, and processes data according to a program provided from the memory 112 to generate a control signal according to a result of the processing.

For example, the processor 111 may be configured to process communication data received through the CAN communication device 120, the mobile communication device 120 and/or the traffic information receiver 140, and generate a control signal for controlling operations of the electric components 30 and/or the wireless communication apparatus 100 according to the result of the processing of the communication data. Also, the processor 111 may generate communication data thatto is configured to be transmitted through the mobile communication device 120 and/or the traffic information receiver 140 according to the result of the processing of the communication data.

Accordingly, the controller 110 may collect communication data from the CAN communication device 120, the mobile communication device 130 and/or the traffic information receiver 140, and process the collected communication data. Also, the controller 110 may control the CAN communication device 120, the mobile communication device 120 and/or the traffic information receiver 140 according to the collected communication data, and transmit communication data through the CAN communication device 120, the mobile communication device 120 and/or the traffic information receiver 140.

For example, the controller 110 may be configured to control the traffic information receiver 140 to communicate with the traffic infrastructure TI, and receive information related to traffic situations from the traffic service server TSV through the traffic infrastructure TI, as shown in FIG. 5. Also, the controller 110 may control the CAN communication device 120 to transmit the received information related to traffic situations to the display 36 through the NT for the vehicle 1.

Also, the controller 110 may be configured to control the mobile communication device 130 to communicate with a communication infrastructure CI or another vehicle V1, and receive multimedia data from the communication infrastructure CI or the other vehicle V1 Also, the controller 110 may be configured to control the CAN communication device 120 to transmit multimedia data to the audio system 38 through the NT for vehicle.

Also, the controller 110 may be configured to control the mobile communication device 130 to perform the handover while communicating with the communication infrastructure CI.

The mobile communication service may use a multiple access technique to accept a plurality of users in a frequency band. However, when a predetermined number of users or more simultaneously access the service, even though the multiple access technique is used (that is, when communication traffic increases), it may be difficult to provide a stable service due to a connection saturation. For the provided reason, a wide region may be divided into a plurality of communication cells (hereinafter, referred to as a first communication cell CL1 and a second communication cell CL2), and a communication infrastructure CI1 and a communication infrastructure CI2 including base stations may be disposed in the respective communication cells CL1 and CL2.

To prevent a mobile communication service from being interrupted when the vehicle 1 passes the communication cell CL1 and the communication cell CL2, the mobile communication device 130 may perform a handover.

As shown in FIG. 6, when the vehicle 1 moves from the first communication cell CL1 in which the first communication infrastructure CI1 is disposed into the second communication cell CL2 in which the second communication infrastructure CI2 is disposed, the wireless communication apparatus 100 may be disconnected from the first communication infrastructure CI1 and connected to the second communication infrastructure CI2.

For example, the wireless communication apparatus 100 may perform a hard handover of disconnecting from the first communication infrastructure CI1 and then connecting to the second communication infrastructure CI2, or a soft handover of connecting to the second communication infrastructure CI2 and then disconnecting from the first communication infrastructure CI1.

In the hard handover, since communications with the communication infrastructures CI1 and CI2 are interrupted, the mobile communication service may be interrupted. In the soft handover, since a simultaneous connection to the communication infrastructures CI1 and CI2 is conducted, communication traffic of the communication infrastructures CI1 and CI2 may increase.

Accordingly, to prevent the mobile communication service from being interrupted, while preventing the communication traffic of the communication infrastructures CI1 and CI2 from increasing, the wireless communication apparatus 100 may perform the handover according to communication traffic of the communication infrastructures CI1 and CI2.

For example, the wireless communication apparatus 100 may receive information related to communication traffic of the communication infrastructures CI1 and CI2 from the traffic infrastructure TI through the traffic information receiver 140, and determine whether to perform the handover, based on the information related to the communication traffic of the communication infrastructures CI1 and CI2.

According to another example, the wireless communication apparatus 100 may receive information related to communication traffic of the communication infrastructures CI1 and CI2 from the communication infrastructures CI1 and CI2, before performing the handover, and then determine whether to perform the handover based on the information related to the communication traffic of the communication infrastructures CI1 and CI2.

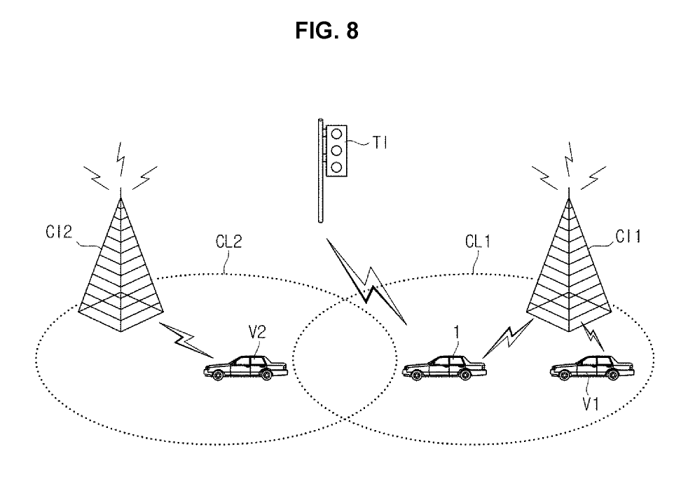

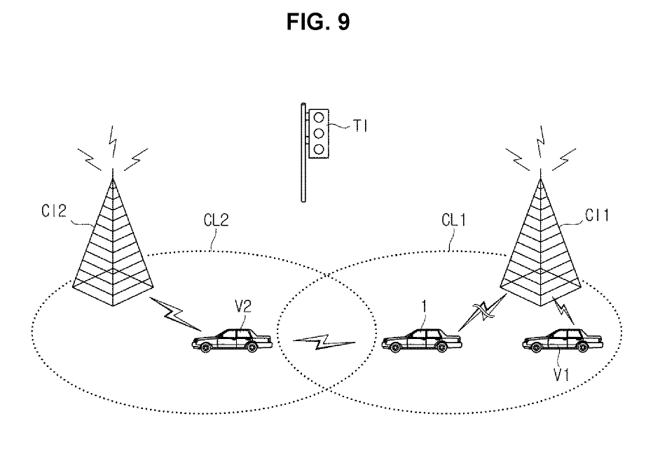

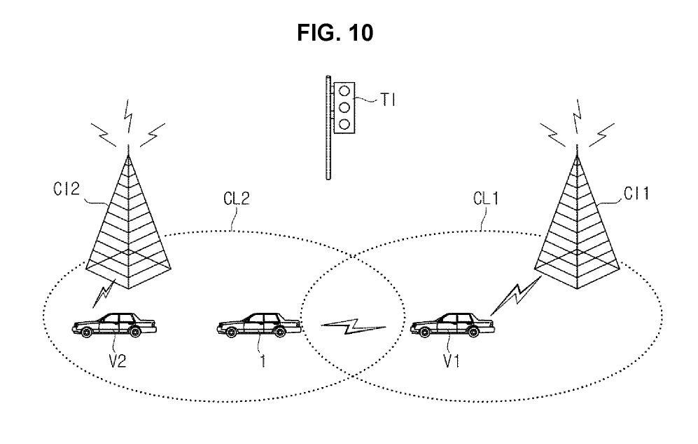

FIG. 7 is a flowchart illustrating a handover method of a vehicle according to an exemplary embodiment of the present invention. FIG. 8 is a view for describing an exemplary embodiment in which a vehicle according to an exemplary embodiment of the present invention performs a handover between communication infrastructures. FIG. 9 is a view for describing another exemplary embodiment in which a vehicle according to an exemplary embodiment of the present invention performs a handover between communication infrastructures. FIG. 10 is a view for describing yet another exemplary embodiment in which a vehicle according to an exemplary embodiment of the present invention performs a handover between communication infrastructures.

Hereinafter, a handover method 1000 of the wireless communication apparatus 100 will be described with reference to FIG. 7, FIG. 8, FIG. 9, and FIG. 10.

The vehicle 1 may receive communication state information related to the communication infrastructures CI1 and CI2, in operation 1010.

The wireless communication apparatus 100 of the vehicle 1 may receive the communication state information related to the communication infrastructures CI1 and CI2 from the traffic infrastructure TI or the communication infrastructures CI1 and CI2. The wireless communication apparatus 100 may receive communication traffic information related to the communication infrastructures CI1 and CI2. Also, the communication traffic information related to the communication infrastructures CI1 and CI2 may include information related to a current connection capability of the communication infrastructures CI1 and CI2 and a maximum connection capability of the communication infrastructures CI1 and CI2.

For example, the wireless communication apparatus 100 may receive communication traffic information related to the communication infrastructures CI1 and CI2 from the traffic service server TSV through the traffic infrastructure TI.

The traffic service server TSV may collect the communication traffic information related to the communication infrastructures CI1 and CI2 through the communication service server CSV, or collect the communication traffic information related to the communication infrastructures CI1 and CI2 directly from the communication infrastructures CI1 and CI2. Also, the traffic service server TSV may transmit the communication traffic information related to the communication infrastructures CI1 and CI2 to the traffic infrastructure TI. For example, the traffic service server TSV may selectively transmit the communication traffic information related to the communication infrastructures CI1 and CI2 located adjacent to the traffic infrastructure TI, based on a position of the traffic infrastructure TI.

The traffic infrastructure TI may transmit the received communication traffic information related to the communication infrastructures CI1 and CI2 to the vehicle 1. For example, as shown in FIG. 8, the wireless communication apparatus 100 may receive the communication traffic information related to the first and second communication infrastructures CI1 and CI2 from the traffic infrastructure TI.

According to another example, the wireless communication apparatus 100 may receive the communication traffic information related to the communication infrastructures CI1 and CI2 from the communication service server CSV through the communication infrastructures CI1 and CI2.

The communication service server CSV may collect the communication traffic information related to the communication infrastructures CI1 and CI2. Also, the communication service server CSV may transmit the communication traffic information related to the communication infrastructures CI1 and CI2 to the communication infrastructures CI1 and CI2. For example, the communication service server CSV may selectively transmit the communication traffic information related to the communication infrastructures CI1 and CI2 located adjacent to the communication infrastructures CI1 and CI2 based on positions of the communication infrastructures CI1 and CI2.

The respective communication infrastructures CI1 and CI2 may transmit the received communication traffic information related to the communication infrastructures CI1 and CI2 to the vehicle 1. For example, as shown in FIG. 8, the wireless communication apparatus 100 may receive the communication traffic information related to the first and second communication infrastructures CI1 and CI2 from the first communication infrastructure CI1 to which it is currently connected.

According to another example, the wireless communication apparatus 100 may receive the communication traffic information related to the communication infrastructure CI1 to which it is currently connected, directly from the communication infrastructure CI1.

The communication infrastructure CI1 may transmit its own communication traffic information to the vehicle 1, while communicating with the vehicle 1. The wireless communication apparatus 100 may receive the communication traffic information related to the communication infrastructure CI1 to which the vehicle 1 is connected.

As such, the vehicle 1 may determine a handover determination index based on the communication traffic information related to the communication infrastructures CI1 and CI2, in operation 1020.

The handover determination index may be an index for determining whether the vehicle 1 needs to perform a handover based on the communication traffic of the communication infrastructures CI1 and CI2. The wireless communication apparatus 100 of the vehicle 1 may determine whether to perform the handover, based on the handover determination index.

To determine the handover determination index, the wireless communication apparatus 100 may determine margin rates of the communication capability from the current connection capability of the communication infrastructures CI1 and C12 and the maximum connection capability of the communication infrastructures CI1 and C12. The margin rates of the communication capability may represent additional connection capability of the communication infrastructures CI1 and C12, and be determined by a ratio of the maximum connection capability of the communication infrastructures CI1 and C12 to the current connection capability of the communication infrastructures CI1 and C12.

The margin rates of the communication capability of the communication infrastructures CI1 and C12 may be respectively determined by Equation (1) and Equation (2) below.

$${α}_{1} = \frac{{C}_{1}}{{T}_{1}} ↵ , \qquad ( 1 )$$

where α₁ represents a margin rate of the communication capability of the first communication infrastructure, C₁ represents a maximum connection capability of the first communication infrastructure, and T₁ represents a current connection capability of the first communication infrastructure.

$${α}_{2} = \frac{{C}_{2}}{{T}_{2}} ↵ , \qquad ( 2 )$$

where α₂ represents a margin rate of the communication capability of the second communication infrastructure, C₂ represents a maximum connection capability of the second communication infrastructure, and T₂ represents a current connection capability of the second communication infrastructure.

As such, the wireless communication apparatus 100 may determine a handover determination index from the magin rates α₁ and α₂ of the communication capability of the communication infrastructures CI1 and CI2. As described above, the handover determination index may be an index for determining whether to perform a handover, and may be determined by a ratio of the margin rate of the communication capability of the communication infrastructure CI2 to which the wireless communication apparatus 100 will be newly connected to the margin rate of the communication capability of the communication infrastructure CI1 to which the wireless communication apparatus 100 is currently connected.

For example, as shown in FIG. 8, when the vehicle 1 moves from the first communication cell CL1 of the first communication infrastructure CI1 to the second communciation cell CL2 of the second communication infrastructure CI2, the wireless communication apparatus 100 may determine a handover determination index of the second communication infrastructure CI2 with respect to the first communication infrastructure CI1.

The handover determination index may be determined by a ratio of the margin rate α₂ of the communication capability of the second communication infrastructure CI2 with respect to the margin rate α₁ of the communication capability of the first communication infrastructure CI1, as expressed by Equation (3) below. The handover determination index may be a ratio of an additional connection capability of the second communication infrastructure CI2 with respect to an additional connection capability of the first communication infrastructure CI1.

$$γ = \frac{{α}_{2}}{{α}_{1}} ↵ , \qquad ( 3 )$$

where γ represents the handover determination index, α₁ represents the margin rate of the communication capability of the first communication infrastructure, and α₂ represents the margin rate of the communication capability of the second communication infrastructure.

As such, the vehicle 1 may determine whether the handover determination index is greater than a reference value, in operation 1030.

The wireless communication apparatus 100 may determine a handover determination index γ for determining whether to perform a handover, and determine whether to perform the handover based on the handover determination index γ. The wireless communication apparatus 100 may compare the handover determination index γ to the reference value to determine whether to perform the handover.

As described above, the handover determination index γ may be a ratio of the additional connection capability of the second communication infrastructure CI2 with respect to the additional connection capability of the first communication infrastructure CI1.

Accordingly, when the handover determination index γ is greater than 1, it can be determined that the additional connection capability of the second communication infrastructure CI2 is greater than the additional connection capability of the first communication infrastructure CI1. In other words, it can be determined that communication traffic of the second communication infrastructure CI2 is less than communication traffic of the first communication infrastructure CI1.

Further, when the handover determination index γ is less than 1, it can be determined that the additional connection capability of the second communication infrastructure CI2 is less than the additional connection capability of the first communication infrastructure CIl. In other words, it can be determined that communication traffic of the second communication infrastructure CI2 is greater than communication traffic of the first communication infrastructure CI1.

When the communication traffic of the second communication infrastructure C12 is less than the communication traffic of the first communication infrastructures CI1, it is preferable to perform the handover. Accordingly, the reference value may be set to a value which is greater than 1. For example, the reference value may be decided as a value between 1 and 2 (A value between 1.2 and 2.).

When the handover determination index γ is greater than the reference value (“YES” in operation 1030), the vehicle 1 may perform the handover in operation 1040.

When the handover determination index γ is greater than the reference value, it can be determined that the communication traffic of the second communication infrastructure CI2 is less than the communication traffic of the first communication infrastructure CI1. Accordingly, to prevent a communication service from being interrupted while reducing communication traffic of the first communication infrastructure CI1, the vehicle 1 may perform the handover to the second communication infrastructure CI2. The wireless communication apparatus 100 may be connected to the second communication infrastructure CI2, and simultaneously may be disconnected from the first communication infrastructure CI1.

Further, when a communication with the second communication infrastructure CI2 is unstable, the wireless communication apparatus 100 may maintain a connection to the second communication infrastructure CI2 using a V2V communication with other vehicles V2 surrounding the vehicle 1.

For example, when the vehicle 1 is not located in the second communication cell CL2 of the second communication infrastructure CI2, the wireless communication apparatus 100 may communicate with the second communication infrastructure CI2 using a V2V communication with a second vehicle V2 located in the second communication cell CL2, as shown in FIG. 9. In other words, the wireless communication apparatus 100 may communicate with the second communication infrastructure CI2 using a multi-hop relay communication method.

when the vehicle 1 is not located in the second communication cell CL2 of the second communication infrastructure CI2, the wireless communication apparatus 100 may search for a vehicle located in the second communication cell CL2 through the V2V communication. When a second vehicle V2 located in the second communication cell CL1 is found, the wireless communication apparatus 100 may require the second vehicle V2 to allow a multi-hop relay communication. When the second vehicle V2 allows a multi-hop relay communication, the wireless communication apparatus 100 may perform a multi-hop relay communication with the second communication infrastructure CI2 through the second vehicle V2.

When the handover determination index γ is not greater than the reference value (“NO” in operation 1030 ), the vehicle 1 may prevent the handover, in operation 1050.

When the handover determination index γ is less than the reference value, it may be determined that the communication traffic of the second communication infrastructure CI2 is greater than the communication traffic of the first communication infrastructure CI1. Accordingly, to prevent a communication service from being interrupted while reducing the communication traffic of the second communication infrastructure CI1, the vehicle 1 may prevent the handover to the second communication infrastructure CI2. The wireless communication apparatus 100 may maintain the connection to the first communication infrastructure CI1.

Further, when a communication with the first communication infrastructure CI1 is unstable, the wireless communication apparatus 100 may maintain the connection to the first communication infrastructure CI1 using V2V communications with other vehicles V1 surrounding the vehicle 1.

For example, when the vehicle 1 is out of the first communication cell CL1 of the first communication infrastructure CI1, the wireless communication apparatus 100 may communicate with the first communication infrastructure CI1 using a V2V communication with a first vehicle V1 located in the first communication cell CL1, as shown in FIG. 10. In other words, the wireless communication apparatus 100 may communicate with the first communication infrastructure CI1 using a multi-hop relay communication method.

When the vehicle 1 is out of the first communication cell CL1 of the first communication infrastructure CI1, the wireless communication apparatus 100 may search for another vehicle located in the first communication cell CL1 using a V2V communication. When a first vehicle V1 located in the first communication cell CL1 is found, the wireless communication apparatus 100 may require the first vehicle V1 to allow a multi-hop relay communication. When the first vehicle V1 allows a multi-hop relay communication, the wireless communication apparatus 100 may perform a multi-hop relay communication with the first communication infrastructure CI1 through the first vehicle V1.

Further, when the vehicle 1 is located at an area where the first communication cell CL1 of the first communication infrastructure CI1 overlaps with the second communication cell CL2 of the second communication infrastructure C12, the vehicle 1 may communicate with the first communication infrastructure CI1 or the second communication infrastructure C12 according to the handover determination index y. For example, when the reference value is assumed to be 2, the vehicle 1 can communicate with the second communication infrastructure C12 when the handover determination index γ is greater than 2. When the handover determination index γ is less than 0.5 (½), the vehicle 1 may communicate with the first communication infrastructure CI1. Further, when the handover determination index γ is less than 2 and greater than 0.5 (½), the vehicle 1 may maintain the communication with the communication infrastructure to which it is currently connected.

As described above, the vehicle 1 may determine whether to perform the handover according to the communication traffic of the communication infrastructures. Further, when the vehicle 1 is out of the communication cells of the communication infrastructures, the vehicle 1 can maintain communications with the communication infrastructures through a multi-hop relay communication based on a V2V communication.

As a result, the vehicle 1 may communicate with the communication infrastructures without a communication interruption. Also, the communication traffic of the communication infrastructures may be reduced.

According to various aspects of the present invention, there are provided a vehicle configured to communicate with a communication infrastructure, a traffic infrastructure, and another vehicle, and a method of controlling the vehicle.

According to various aspects of the present invention, there are provided a vehicle configured to reduce communication traffic of a communication infrastructure through a handover, and a method of controlling the vehicle.

Exemplary embodiments of the present invention have been described above. In the exemplary embodiments described above, some components may be implemented as a “module”. Here, the term ‘module’ means, but is not limited to, a software and/or hardware component, including a Field Programmable Gate Array (FPGA) or Application Specific Integrated Circuit (ASIC), which performs certain tasks. A module may advantageously be configured to reside on the addressable storage medium and configured to execute on one or more processors.

Thus, a module may include, by way of example, components, including software components, object-oriented software components, class components and task components, processes, functions, attributes, procedures, subroutines, segments of program code, drivers, firmware, microcode, circuitry, data, databases, data structures, tables, arrays, and variables. The operations provided for in the components and modules may be combined into fewer components and modules or further separated into additional components and modules. In addition, the components and modules may be implemented wherein they execute one or more CPUs in a device.

With that being the, and in addition to the above described exemplary embodiments, embodiments can thus be implemented through computer readable code/instructions in/on a medium, e.g., a computer readable medium, to control at least one processing element to implement any above described exemplary embodiments. The medium can correspond to any medium/media permitting the storing and/or transmission of the computer readable code.

The computer-readable code can be recorded on a medium or transmitted through the Internet. The medium may include Read Only Memory (ROM), Random Access Memory (RAM), Compact Disk-Read Only Memories (CD-ROMs), magnetic tapes, floppy disks, and optical recording medium. Also, the medium may be a non-transitory computer-readable medium. The media may also be a distributed network, so that the computer readable code is stored or transferred and executed in a distributed fashion. Still Furthermore, as only an example, the processing element may include at least one processor or at least one computer processor, and processing elements may be distributed and/or included in a single device.

For convenience in explanation and accurate definition in the appended claims, the terms “upper”, “lower”, “up”, “down”, “upwards”, “downwards”, “internal”, “outer”, “inside”, “outside”, “inwardly”, “outwardly”, “internal”, “external”, “front”, “rear”, “back”, “forwards”, and “backwards” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described to explain certain principles of the invention and their practical application, to enable others skilled in the art to make utilize various exemplary embodiments of the present invention, as well as various alternatives and modifications thereof. It is intended that the scope of the invention be defined by the Claims appended hereto and their equivalents.

What is claimed is:

1. A vehicle comprising:
a mobile communication device configured to communicate with a first communication infrastructure among a plurality of communication infrastructures;
a traffic information receiver configured to communicate with a traffic infrastructure; and
a controller configured to receive information related to communication states of the plurality of communication infrastructures from the traffic infrastructure through the traffic information receiver, and to perform a handover from the first communication infrastructure to a second communication infrastructure according to a first communication state information related to the first communication infrastructure and a second communication state information related to the second communication infrastructure.

2. The vehicle according to claim 1, wherein the controller is configured to determine a first additional connection capability and a second additional connection capability from the first communication state information and the second communication state information, and prevents the handover from the first communication infrastructure to the second communication infrastructure, when a ratio of the second additional connection capability to the first additional connection capability is less than or equal to a reference value.

3. The vehicle according to claim 2, wherein, when the controller prevents the handover and then is configured to determine that the vehicle is out of a communication cell of the first communication infrastructure, the controller is configured to perform a Vehicle-to-Vehicle (V2V) communication with a first vehicle located in the communication cell of the first communication infrastructure, and performs a multi-hop relay communication with the first communication infrastructure using the V2V communication with the first vehicle.

4. The vehicle according to claim 1, wherein the controller is configured to determine a first additional connection capability and a second additional connection capability from the first communication state information and the second communication state information, and performs the handover from the first communication infrastructure to the second communication infrastructure, when a ratio of the second additional connection capability to the first additional connection capability is greater than a reference value.

5. The vehicle according to claim 4, wherein, when the controller performs the handover and then is configured to determine that the vehicle is out of a communication cell of the second communication infrastructure, the controller is configured to perform a Vehicle-to-Vehicle (V2V) communication with a second vehicle located in the communication cell of the second communication infrastructure, and performs a multi-hop relay communication with the second communication infrastructure using the V2V communication with the second vehicle.

6. The vehicle according to claim 1, wherein the controller is configured to extract a first current connection capability and a first maximum connection capability from the first communication state information, is configured to determine a first margin rate of the communication capability representing a ratio of the first maximum connection capability to the first current connection capability, extracts a second current connection capability and a second maximum connection capability from the second communication state information, and is configured to determine a second margin rate of the communication capability representing a ratio of the second maximum connection capability to the second current connection capability.

7. The vehicle according to claim 6, wherein when a ratio of the second margin rate of the communication capability to the first margin rate of the communication capability is less than or equal to a reference value, the controller is configured to prevent the handover from the first communication infrastructure to the second communication infrastructure, and when the ratio of the second margin rate of the communication capability to the first margin rate of the communication capability is greater than the reference value, the controller is configured to perform the handover from the first communication infrastructure to the second communication infrastructure.

8. A method of controlling a vehicle, comprising:
communicating with a first communication infrastructure among a plurality of communication infrastructures;
communicating with a traffic infrastructure;
receiving information related to communication states of the plurality of communication infrastructures from the traffic infrastructure; and
performing a handover from the first communication infrastructure to the second communication infrastructure according to a first communication state information related to the first communication infrastructure and a second communication state information related to the second communication infrastructure.

9. The method according to claim 8, wherein the performing of the handover includes:
determining a first additional connection capability and a second additional connection capability from the first communication state information and the second communication state information; and
preventing the handover from the first communication infrastructure to the second communication infrastructure, when a ratio of the second additional connection capability to the first additional connection capability is less than or equal to a reference value.

10. The method according to claim 9, further including:
when preventing the handover and then determining that the vehicle is out of a communication cell of the first communication infrastructure, performing a Vehicle-to-Vehicle (V2V) communication with a first vehicle located in the communication cell of the first communication infrastructure; and
performing a multi-hop relay communication with the first communication infrastructure using the V2V communication with the first vehicle.

11. The method according to claim 8, wherein the performing of the handover includes:
determining a first additional connection capability and a second additional connection capability from the first communication state information and the second communication state information; and
performing the handover from the first communication infrastructure to the second communication infrastructure, when a ratio of the second additional connection capability to the first additional connection capability is greater than a reference value.

12. The method according to claim 11, further including:
when performing the handover and then determining that the vehicle is out of a communication cell of the second communication infrastructure, performing a Vehicle-to-Vehicle (V2V) communication with a second vehicle located in the communication cell of the second communication infrastructure; and
performing a multi-hop relay communication with the second communication infrastructure using the V2V communication with the second vehicle.

13. The method according to claim 8, wherein the performing of the handover includes:
extracting a first current connection capability and a first maximum connection capability from the first communication state information;
determining a first margin rate of the communication capability representing a ratio of the first maximum connection capability to the first current connection capability;
extracting a second current connection capability and a second maximum connection capability from the second communication state information; and
determining a second margin rate of the communication capability representing a ratio of the second maximum connection capability to the second current connection capability.

14. The method according to claim 8, wherein the performing of the handover further includes:
preventing the handover from the first communication infrastructure to the second communication infrastructure, when a ratio of the second margin rate of the communication capability to the first margin rate of the communication capability is less than or equal to a reference value; and
performing the handover from the first communication infrastructure to the second communication infrastructure, when the ratio of the second margin rate of the communication capability to the first margin rate of the communication capability is greater than the reference value.

15. A vehicle configured to communicate with a plurality of communication infrastructures, comprising:
a mobile communication device configured to communicate with a first communication infrastructure among the plurality of communication infrastructures; and
a controller configured to receive information related to communication states of the plurality of communication infrastructures from the first communication infrastructure, and to prevent or perform a handover from the first communication infrastructure to a second communication infrastructure according to a first communication state information related to the first communication infrastructure and a second communication state information related to the second communication infrastructure;
wherein when the controller prevents the handover and then, is configured to determine that the vehicle is out of a communication cell of the first communication infrastructure, the controller performs a multi-hop relay communication with the first communication infrastructure using a Vehicle-to-Vehicle (V2V) communication with a first vehicle located in the communication cell of the first communication infrastructure, and
when the controller performs the handover and then, is configured to determine that the vehicle is out of a communication cell of the second communication infrastructure, the controller performs a multi-hop relay communication with the second communication infrastructure using a V2V communication with a second vehicle located in the communication cell of the second communication infrastructure.

16. The vehicle according to claim 15, wherein the controller is configured to determine a first additional connection capability and a second additional connection capability from the first communication state information and the second communication state information, and prevents the handover from the first communication infrastructure to the second communication infrastructure, when a ratio of the second additional connection capability to the first additional connection capability is less than or equal to a reference value.

17. The vehicle according to claim 15, wherein the controller is configured to determine a first additional connection capability and a second additional connection capability from the first communication state information and the second communication state information, and performs the handover from the first communication infrastructure to the second communication infrastructure, when a ratio of the second additional connection capability to the first additional connection capability is greater than a reference value.

18. The vehicle according to claim 15, wherein the controller is configured to extract a first current connection capability and a first maximum connection capability from the first communication state information, and extracts a second current connection capability and a second maximum connection capability from the second communication state information.

19. The vehicle according to claim 18, wherein the controller is configured to determine a first margin rate of the communication capability representing a ratio of the first maximum connection capability to the first current connection capability, and is configured to determine a second margin rate of the communication capability representing a ratio of the second maximum connection capability to the second current connection capability.

20. The vehicle according to claim 19, wherein when a ratio of the second margin rate of the communication capability to the first margin rate of the communication capability is less than or equal to a reference value, the controller is configured to prevent the handover from the first communication infrastructure to the second communication infrastructure, and when the ratio of the second margin rate of the communication capability to the first margin rate of the communication capability is greater than the reference value, the controller is configured to perform the handover from the first communication infrastructure to the second communication infrastructure.
